(19) United States
(12) Patent Application Publication
(10) Pub. No.: US 2004/0243919 A1
(43) Pub. Date: Dec. 2, 2004

(54) Synchronized processing of views and drawing tools in a multiple document interface application

(76) Inventors: David Darian Muresan, Seattle, WA (US); David Muresan, Seattle, WA (US)

Correspondence Address: DAVID DARIAN MURESAN, 18204 30TH AVE NE, SEATTLE, WA, 98155, US

(21) Appl. No.: 10/406,188

(22) Filed: Apr. 4, 2003

(51) Int. Cl. G06F 17/00

(52) U.S. Cl. 715/500

(57) ABSTRACT

For graphic artists, medical image specialists, image processing researchers, and many others, the ability to apply the same view and drawing tools to multiple opened windows (i.e. images in windows) is a must. This invention describes a method where in a multiple document interface application the views and drawing tools information is sent out to all opened windows in the parent application so that images in different windows can be synchronized with the image in the active window.

### BACKGROUND OF THE INVENTION

The need to easily compare and inspect multiple images at once is something that has been missed in the software development and image processing world. In Microsoft Windows programming, multiple document interface programs allow the user to open up multiple windows, also called child windows, inside of the main application, sometimes called the client window. In Microsoft Windows the client window is responsible for sending messages to all of the child windows. A message can be sent to all of the opened child windows using the API command EnumChildWindows. All the image processing applications available today allow users to open multiple images in different child windows (8,9,10) but they do not allow the user to easily compare all the images at once by having the view setting in one child window sent to all of the other children. More specifically, we assume that child A and child B, each contain an image of the same size. Further, we want to view the same exact region of both images in window A and window B. With today's software one would have to scroll and zoom into image A first, then return to image B and scroll and zoom into image B, such that both images in window A and window B view approximately the same region. This procedure is cumbersome, frustrating, and often very time consuming. Our invention attempts to eliminate this drawback through the use of the function EnumChildWindows in Microsoft Windows (or other similar function in non-Microsoft operating systems).

### BRIEF SUMMARY OF THE INVENTION

Our invention can be summarized as follows:

1. In a multiple document interface application, select whether or not the view and drawing tools should apply to all opened windows. (When they apply to all windows we say that the windows are synchronized.) The existence of a selection option allows for the software user to turn on or off window synchronization.

2. If the user wants synchronization to be off, then the multiple document interface (MDI) application behaves like any other multiple document interface applications.

3. If the user wants synchronization to be turned on for the views, then position and zoom information about the active child window is sent and applied to all other child windows.

4. If the user wants synchronization to be turned on for the drawing tools, then the tool information from the active child window is sent and applied to all other child windows.

### BRIEF DESCRIPTION OF THE DRAWINGS

FIG. 1 The parent-child hierarchy of a Windows Multiple Document Interface (MDI) application.

FIG. 2 The procedure described in this invention. When a message comes to child one View, Drawing Tools, or any other information is saved in the struct INFO. If window synchronization is turned off, the function ProcessMsg is called directly. If window synchronization is turned on, then EnumChildWindows procedure is called with a pointer to function ProcessMsg.

FIG. 3. The function EnumChildWindows takes as input the client window handle, the pointer to function ProcessMsg, and the pointer to struct INFO.

FIG. 4. The function ProcessMsg processes the message for a child window. It takes as input the child window handle and the pointer to struct INFO.

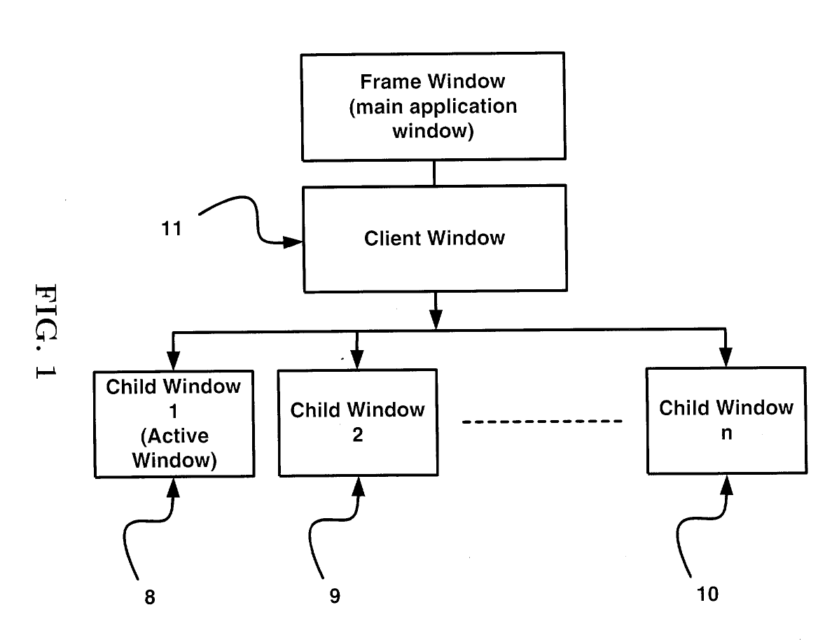

### DETAILED DESCRIPTION OF THE INVENTION

The present invention will be described in detail in relationship to the Microsoft Windows operating system. It should be understood, however, that the invention is broadly applicable to graphical, event-driven computer systems of all types, as well as to different graphical user interfaces including, for example, X Windows, AUX, MOTIF, Macintosh, etc.

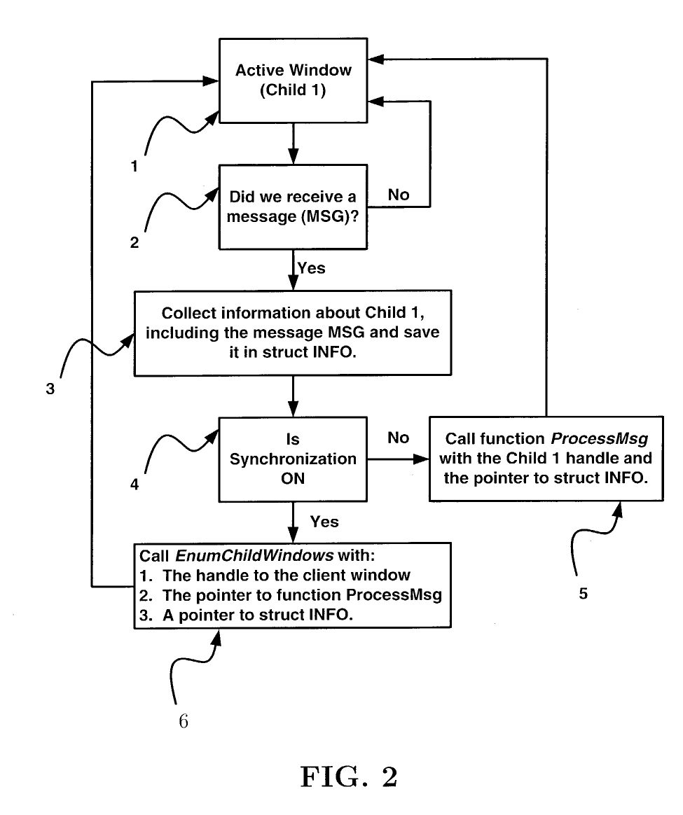

The procedure of this invention is described in FIG. 2. First, struct INFO is defined as being a struct capable of bolding any information about the active child window. The active child window is always labeled child member one (1). The active child (1) waits for a, message MSG (2). When message MSG is received by child one (1) any information about the window, including but not limited to

1. Window message (MSG)

2. Child window position

3. Scroll bar position

4. Zoom factor

5. Mouse position

6. Mouse buttons' state

7. Keyboard state

is saved in the struct INFO. This step is depicted in (3). Next, the program checks if the user wants the windows to be synchronized. If the windows are not synchronized, then the program calls function ProcessMsg with the handle of child one and the pointer to struct INFO. If the user wants the windows to be synchronized, then the program calls EnumChildWindows with a handle to the client window (11) (which can be obtained using the windows API function GetParent), the pointer to function ProcessMsg, and the pointer to struct INFO.

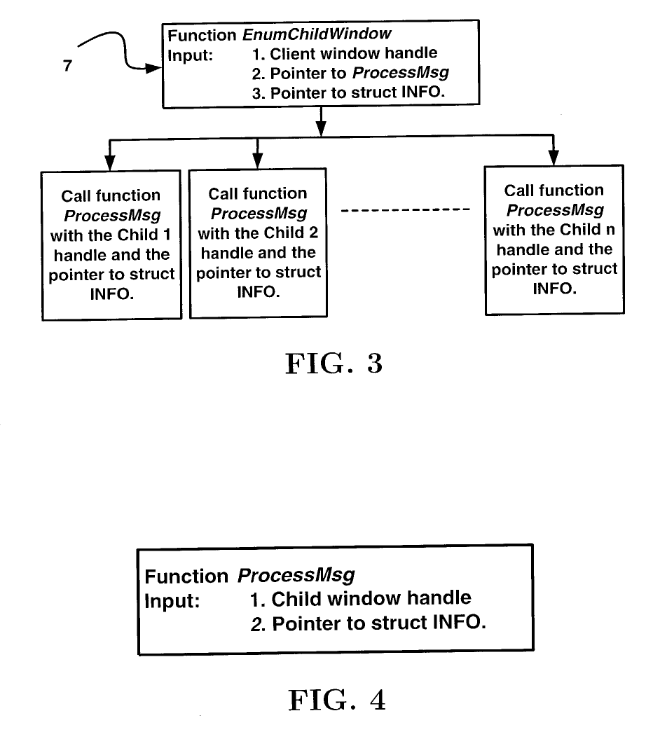

The EnumChildWindows function (FIG. 3) enumerates the child windows that belong to the specified client window (11) by passing the handle to each child window (8, 9, 10), in turn, to the application-defined callback function ProcessMsg. The function EnumChildWindows also passes the pointer of struct INFO to ProcessMsg. The function ProcessMsg (FIG. 4) takes as input a, handle to the child window and a pointer to struct INFO. The job of function ProcessMsg is to update the child window (specified by the window handle) with the data in the INFO struct. This may include updating

1. Window position

2. Scroll bar position

3. Window zoom factor

4. Window drawings

5. Window editing function

or any other information specified in strict INFO or specific to each window.

We claim:

1. A procedure for controlling the window display in a multiple document interface program that has n child windows and comprising of
a function ProcessMsg that takes as input a child window handle and information (for example, the pointer to a, strict named INFO) that is used by the said function to update the window pointed to by the said window handle;
saving the mouse position, mouse state, window message, keyboard state, and any other information of the active child window (for example, saving it to strict INFO);
calling the said function (ProcessMsg) n times, and each time with a handle to a different child window and with the said saved information (for example, the pointer to struct INFO).

2. A procedure for controlling the window display in a, multiple document interface program that has n child windows and comprising of
a function ProcessMsg that takes as input a child window handle and information (for example, the pointer to a struct named INFO) that is used by the said function to update the scroll position and the zoom factor of the window pointed to by the said window handle;
saving the scroll bar position and zoom factor information of the active child window (for example, saving it to struct INFO);
calling the said function (ProcessMsg) n times, and each time with a handle to a different child window and with the said saved information (for example, the pointer to struct INFO).

3. A procedure for controlling the window display in a multiple document interface program that has n child windows and comprising of
a function ProcessMsg that takes as input a child window handle and information (for example, the pointer to a struct named INFO) that is used by the said function to apply the drawing information to the window pointed to by the said window handle;
saving the drawing information of the active child window (for example, saving it to struct INFO);
calling the said function (ProcessMsg) n times, and each time with a handle to a different child window and with the said saved information (for example, the pointer to struct INFO).
